(19) United States
(12) Patent Application Publication
(10) Pub. No.: US 2012/0299854 A1
(43) Pub. Date: Nov. 29, 2012

(54) MOBILE ELECTRONIC DEVICE AND INPUT METHOD

(75) Inventor: Nobuo Kawai, Kanagawa (JP)

(73) Assignee: KYOCERA CORPORATION, Kyoto (JP)

(21) Appl. No.: 13/481,094

(22) Filed: May 25, 2012

(30) Foreign Application Priority Data
May 25, 2011 (JP) 2011-116715
May 23, 2012 (JP) 2012-117941

(51) Int. Cl. G06F 3/041

(52) U.S. Cl. 345/173

(57) ABSTRACT

An object of the present invention is to provide a mobile electronic device and an input method thereof, all of which are capable of canceling a restricting feature for preventing erroneous operations, and capable of quickly executing a desired feature. In a restricted state, in a case in which a control unit determines that a touch detected by a detecting unit is a first touching operation, the control unit cancels the restricted state, and causes a display unit to display a screen that was displayed before the restricted state, and in a case in which the control unit determines that the touch thus detected is a second touching operation, the control unit cancels the restricted state, and executes a predetermined function.

This application is based on and claims the benefit of priority from Japanese Patent Application Nos. 2011-116715 and 2012-117941, respectively filed on 25 May 2011 and filed on 23 May 2012, the content of which is incorporated herein by reference.

### BACKGROUND OF THE INVENTION

1. Field of the Invention

The present invention relates to a mobile electronic device that includes a display unit, and to an input method thereof.

2. Related Art

Conventionally, with a mobile electronic device including a touch panel, when a desired feature is executed from a power-saving state, the desired feature needs to be executed after canceling a restricting feature for preventing erroneous touch-panel operations. A technology as disclosed in Japanese Unexamined Patent Application, Publication No. 2008-243149 has been proposed as a restricting feature for preventing such erroneous touch-panel operations.

However, with the mobile electronic device described above, there is a possibility that the desired feature cannot quickly be executed because it is necessary to execute the desired feature after cancelling the restricting feature for preventing erroneous touch-panel operations.

### SUMMARY OF THE INVENTION

An object of the present invention is to provide a mobile electronic device and an input method thereof, all of which are capable of canceling the restricting feature for preventing erroneous touch-panel operations, and capable of quickly executing the desired feature.

In order to solve the aforementioned problem, the mobile electronic device according to the present invention includes a display unit, a detecting unit, and a control unit. The detecting unit is correspondingly disposed in a surface of the display unit, and detects a touch to a surface thereof. The control unit determines a touching operation based on the touch detected by the detecting unit. In a restricted state where the touching operation is restricted, in a case in which the control unit determines that the touch thus detected is a first touching operation, the control unit cancels the restricted state, and causes the display unit to display a screen that was displayed before transitioning to the restricted state. In a case in which the control unit determines that the touch thus detected is a second touching operation, the control unit cancels the restricted state, and executes a predetermined feature.

It is preferable for the mobile electronic device to further include an operation key. It is preferable for the control unit to cancel the power-saving state when the operation key is operated.

It is preferable for the second touching operation to be a second sliding operation having a predetermined path. It is preferable for the control unit to set the second sliding operation in association with the predetermined feature, and executes the predetermined feature in a case in which the control unit determines that the touch thus detected is the second sliding operation.

In order to solve the aforementioned problem, the mobile electronic device according to the present invention includes a display unit, a detecting unit, and a control unit. The detecting unit is correspondingly disposed in a surface of the display unit, and detects a touch to a surface thereof. The control unit determines a touching operation based on the touch detected by the detecting unit, and includes a character recognition feature for recognizing the touching operation as a character. In a restricted state where the touching operation is restricted, in a case in which the control unit determines that the touch thus detected is a predetermined sliding operation, the control unit executes a character input feature for cancelling the restricted state using a password, and performs displaying in a state where a character recognized by the character recognition feature based on the predetermined sliding operation is input into the character input feature.

In order to solve the aforementioned problem, the input method according to the present invention includes the steps of: determining that a touch detected by a detecting unit is a first touching operation or a second touching operation, in a restricted state where a touching operation is restricted; cancelling the restricted state and displaying a screen that was displayed before the restricted state, in a case in which the touch is determined to be the first touching operation; and cancelling the restricted state and executing a predetermined feature, in a case in which the touch is determined to be the second touching operation.

According to the present invention, a desired feature can be quickly executed while canceling a restricting feature for preventing erroneous operations.

### BRIEF DESCRIPTION OF THE DRAWINGS

FIG. 1 is an external perspective view of a mobile telephone device according to an embodiment of the present invention;

FIG. 2 is a functional block diagram of features of the mobile telephone device according to the embodiment of the present invention;

FIGS. 3(a) to 3(i) are examples of screen transitions displayed on a display unit according to the embodiment of the present invention;

FIG. 4 is a flowchart showing internal processing of a control unit according to the embodiment of the present invention; and

FIG. 5 is a flowchart showing processing for canceling a restricted state using a password, in the control unit according to the embodiment of the present invention.

### DETAILED DESCRIPTION OF THE INVENTION

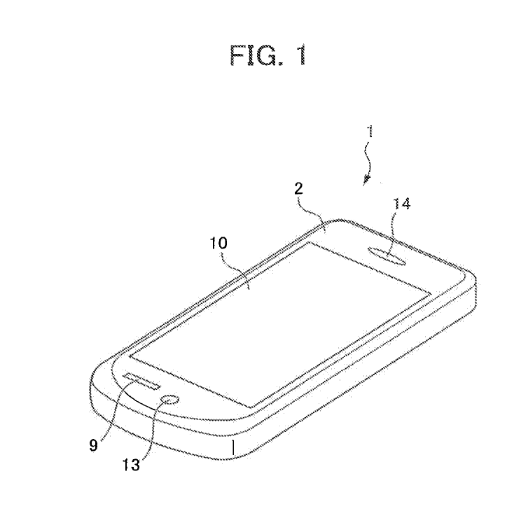

Descriptions are provided hereinafter regarding an embodiment of the present invention. First of all, with reference to FIG. 1, descriptions are provided for a basic structure of a mobile telephone device 1 according to an embodiment of the portable electronic device of the present invention. FIG. 1 is a perspective view showing an appearance of the mobile telephone device 1 according to the present embodiment.

The mobile telephone device 1 includes a body 2. Operation keys 9, a touch panel 10, a microphone 13 and a speaker 14 are disposed on a front face portion of the body 2.

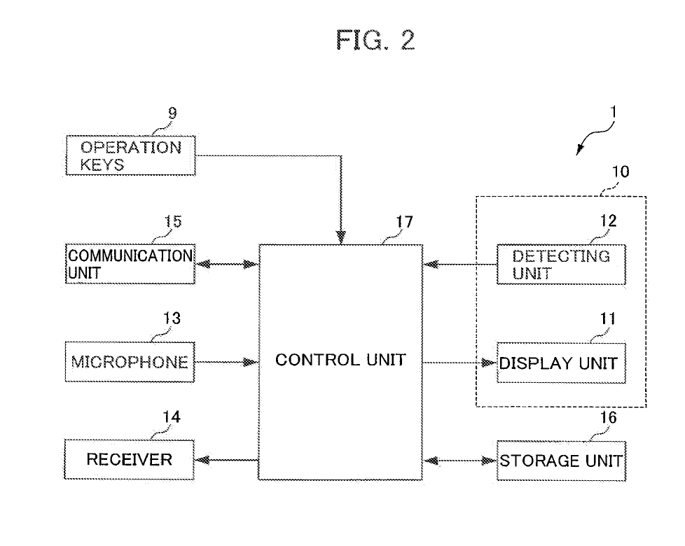

The touch panel 10 includes a display unit 11 and a detecting unit 12 (see FIG. 2). The display unit 11 is a liquid-crystal display panel, an organic EL (electroluminescence) display panel, or the like. The detecting unit 12 is a sensor that detects a touch by an object, such as a finger or stylus of a user of the mobile telephone device 1, on the display unit 11. The detecting unit 12 is correspondingly disposed in the surface of display unit 11, and for example, a sensor that employs a capacitive sensing method or a resistive film method can be utilized as the detecting unit 12.

The microphone 13 is used for inputting sound produced by the user of the mobile telephone device 1 during a telephone call. The speaker 14 is used for outputting sound produced by the other party whom the user of the mobile telephone device 1 is talking with during a phone call.

Next, a functional configuration of the mobile telephone device 1 is described with reference to FIG. 2. FIG. 2 is a block diagram showing a functional configuration of the mobile telephone device 1.

The mobile telephone device 1 includes the operation keys 9, the touch panel 10 (the display unit 11 and the detecting unit 12), the microphone 13, and the speaker 14, as described above. In addition, the mobile telephone device 1 includes a communication unit 15, a storage unit 16, and a control unit 17.

The communication unit 15 includes a main antenna and an RF circuit unit, and makes an outgoing call to and performs communication with a predetermined contact entity. The contact entity, to which the communication unit 15 makes an outgoing call, is an emergency contact entity such as, for example, the police or fire station. Moreover, the contact entity, to which the communication unit 15 makes an outgoing call, is an external device that performs a telephone call or mail transmission/reception with the mobile telephone device 1, or an external device or the like such as an external web server, with which the mobile telephone device 1 establishes Internet connections.

The communication unit 15 performs communication with an external device via a predetermined usable frequency band. More specifically, the communication unit 15 executes demodulation processing of a signal received via the main antenna, and transmits the processed signal to the control unit 17. The communication unit 15 executes modulation processing of a signal transmitted from the control unit 17, and transmits the signal to an external device (base station) via the main antenna.

The storage unit 16 includes, for example, working memory, and is utilized for arithmetic processing by the control unit 17. Furthermore, the storage unit 16 stores a single or plurality of application(s) and database(s) that are operated inside the mobile telephone device 1. It should be noted that the storage unit 16 may also serve as detachable external memory.

The control unit 17 controls the entirety of the mobile telephone device 1, and performs control of the display unit 11, the communication unit 15 and the like.

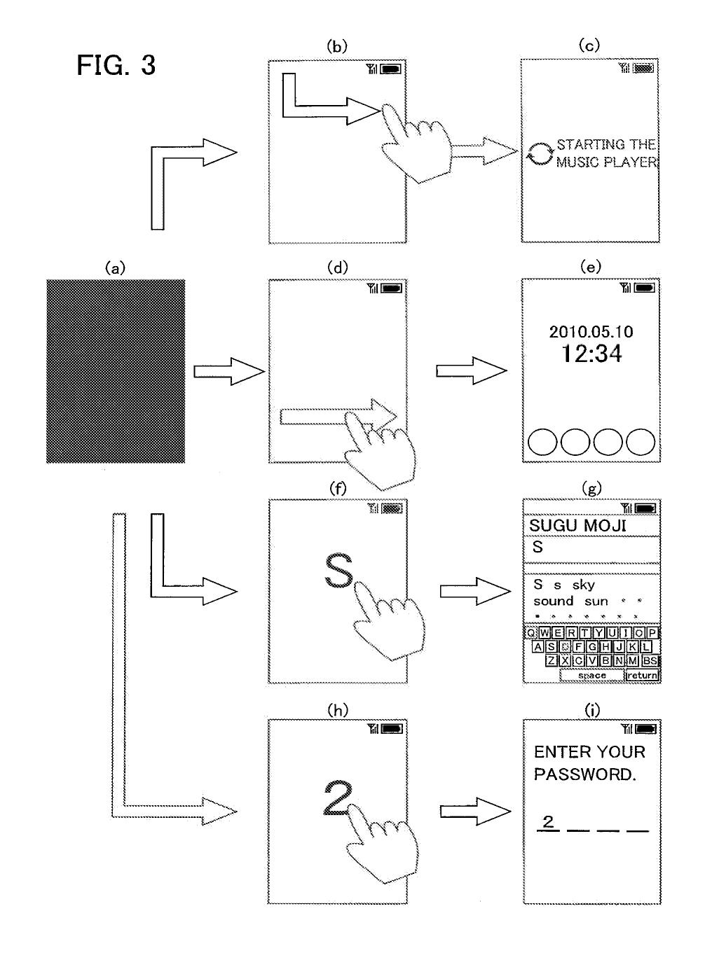

Next, descriptions are provided for processing implemented by the control unit 17 according to the present embodiment with reference to FIG. 3. FIGS. 3(a) to 3(i) are examples of screen transitions displayed on a display unit according to the present embodiment.

The control unit 17 determines a touching operation, based on a touch detected by the detecting unit 12. The control unit 17 includes a feature for transitioning to a restricted state. In the restricted State, touching operations are restricted to a predetermined touching operation. The restricted state can reduce erroneous operations of executing unintended features and applications on the mobile telephone device 1. For example, in a case in which the detecting unit 12 does not detect a touch for more than a predetermined period of time, the control unit 17 transitions to the restricted state.

The control unit 17 includes a feature for transitioning to a power-saving state. In the power-saving state, the detecting of a touch by the detecting unit 12 and the displaying by the display unit 11 are suspended (see FIG. 3(a)). For example, in a case in which the detecting unit 12 does not detect a touch for more than a predetermined period of time in the restricted state, the control unit 17 transitions to the power-saving state. The power-saving state enables the mobile telephone device 1 to reduce power consumption.

When any of the operation keys 9 is operated in the power-saving state, the control unit 17 transitions from the power-saving state to the restricted state. For example, when the operation key 9 is operated, the control unit 17 causes the display unit 11 to start displaying, and causes the detecting unit 12 to start detecting a touch. In a case in which the control unit 17 of the present embodiment transitions from the power-saving state to the restricted state, the control unit 17 executes a character recognition application that recognizes a touch detected by the detecting unit 12 as a character.

The detecting unit 12 detects a touch in the restricted state. When the control unit 17 determines that a detected touch is a first touching operation, the control unit 17 cancels the restricted state. In addition to canceling the restricted state, the control unit 17 causes the display unit 11 to display a screen that was displayed immediately before transitioning to the restricted state.

Here, descriptions are provided for a case in which a first sliding operation of sliding in a horizontal direction (from left to right or from right to left) is set as the first touching operation. In this case, in the restricted state, the control unit 17 determines whether the touch detected by the detecting unit 12 is the first sliding operation. When the control unit 17 determines that the touch is the first sliding operation, the control unit 17 cancels the restricted state (see FIG. 3(d)). In addition to canceling the restricted state, the control unit 17 causes the display unit 11 to display a screen that was displayed immediately before transitioning to the restricted state (see FIG. 3(e)). In this example, the display unit 11 displays an idle screen that was displayed immediately before. It should be noted that the idle screen is a screen on standby for execution of an application including an incoming/outgoing call. An arbitrary wall paper screen can be displayed as the idle screen.

When the control unit 17 determines that the touch detected by the detecting unit 12 is a second touching operation, the control unit 17 cancels the restricted state, and executes a predetermined feature. Here, descriptions are provided for a case in which a second sliding operation having a predetermined path is set as the second touching operation. In this case, in the restricted state, the control unit 17 determines whether the touch detected by the detecting unit 12 is the second sliding operation. When the control unit 17 determines that the touch is the second sliding operation, the control unit 17 cancels the restricted state, and executes a predetermined feature. Here, descriptions are provided for a case in which a sliding operation having an L-shaped path is set as the second sliding operation, and a music player application is set as the predetermined feature. In a case in which the control unit 17 determines that the detected touch is the second sliding operation having an L-shaped path (see FIG. 3(b)), the control unit 17 cancels the restricted state, and executes the music player application (see FIG. 3(c)).

In this way, in a case in which the mobile telephone device 1 determines that the detected touch is the second sliding operation, the mobile telephone device 1 cancels the restricted state, and executes a predetermined feature associated with the second sliding operation. As a result, the mobile telephone device 1 can quickly execute a predetermined feature. In a case in which the first touching operation is detected, the mobile telephone device 1 cancels the restricted state, and causes the display unit 11 to display a screen that was displayed immediately before transitioning to the restricted state. As a result, the mobile telephone device 1 can instantly use a feature that was operated immediately before transitioning to the restricted state. All of the above enable the mobile telephone device 1 to improve the convenience for users.

In a case in which any of the operation keys 9 is operated, the mobile telephone device 1 transitions from the power-saving state to the restricted state, and executes the character recognition application. As a result, the mobile telephone device 1 can quickly execute processing using the character recognition application. With the mobile telephone device 1, a plurality of second touching operations can be set. Here, descriptions are provided for a case in which a third sliding operation having a path that approximates one stroke composing at least one character is set as another second touching operation, and a character input application is set as a feature associated with the third sliding operation. In this case, in the restricted state, the control unit 17 determines whether the touch detected by the detecting unit 12 is the third sliding operation having a path that approximates one stroke composing at least one character. When the control unit 17 determines that the detected touch is the third sliding operation, the control unit 17 cancels the restricted state, and executes the character input application. The control unit 17 performs displaying in a state where a predetermined sliding operation recognized by the character recognition application is input as a character or a part of a character.

More specifically, in a case in which the control unit 17 determines that the touch detected by the detecting unit 12 is a sliding operation having a path that approximates a character “S” (see FIG. 3(f)), the control unit 17 causes the character recognition application to recognize the character “S”, and cancels the restricted state. The control unit 17 executes the character input application, and performs displaying in a state where the character “S” recognized by the character recognition application is input (see FIG. 3(g)). With the character input application shown in FIG. 3(g), a character (for example, “S”) is input at a top level of the screen on the display unit 11, and conversion candidates (for example, “S”, “s”, “sky”, “sound”, “sun” and the like) for the character are displayed at the top level of the middle of the screen. At the bottom level of the screen, a software keyboard (for example the QWERTY-standard keyboard) is displayed.

With this, by using a hand-written character, the mobile telephone device 1 can cancel the restricted state and quickly execute the character input application. The mobile telephone device 1 executes the character input application, and performs displaying in a state where a character recognized by the character recognition application is input. As a result, the convenience of the character input application can be improved.

When detecting characters having a plurality of strokes, such as a character “G”, in a case in which the control unit 17 determines that a touch detected by a plurality of detecting units 12 is a sliding operation having a path that approximates the first stroke of the character “G”, the control unit 17 causes the character recognition application to recognize the first stroke of the character “G”, and cancels the restricted state. The control unit 17 executes the character input application, and performs displaying in a state where the first stroke of the character “G” recognized by the character recognition application is input.

The control unit 17 may cancel the restricted state by using a password. In such a case, the control unit 17 can cancel the restricted state by inputting a password such as preset characters and/or numbers.

In the present embodiment, in the restricted state using a password, in a case in which the control unit 17 determines that the touch detected by the detecting unit 12 is a predetermined sliding operation, the control unit 17 executes the character input application for canceling the restricted state using a password. The control unit 17 executes the character input application, and performs displaying in a state where the predetermined sliding operation recognized by the character recognition application is input as a character into the character input application.

More specifically, in the restricted state using a password, in a case in which the control unit 17 determines that the touch detected by the detecting unit 12 is a sliding operation having a path that approximates the number “2” (see FIG. 3(h)), the control unit 17 causes the character recognition application to recognize the number “2”. The control unit 17 executes the character input application, and performs displaying in a state where the number “2” recognized by the character recognition application is input (see FIG. 3(i)). By inputting numbers continuing after the number “2” in a state shown in FIG. 3(i), the restricted state using a password can be cancelled.

With this, the mobile telephone device 1 can quickly cancel the restricted state using a password.

When detecting characters having a plurality of strokes, such as the number “4”, in a case in which the control unit 17 determines that the touch detected by the detecting unit 12 is a sliding operation having a path that approximates the first stroke of the number “4”, the control unit 17 causes the character recognition application to recognize the first stroke of the number “4”. The control unit 17 executes the character input application, and performs displaying in a state where the first stroke of the number “4” recognized by the character recognition application is input. In a state where the first stroke of the number “4” is input, when the second stroke of the number “4” and numbers continuing after the number “4” are input, the control unit 17 can cancel the restricted state using a password.

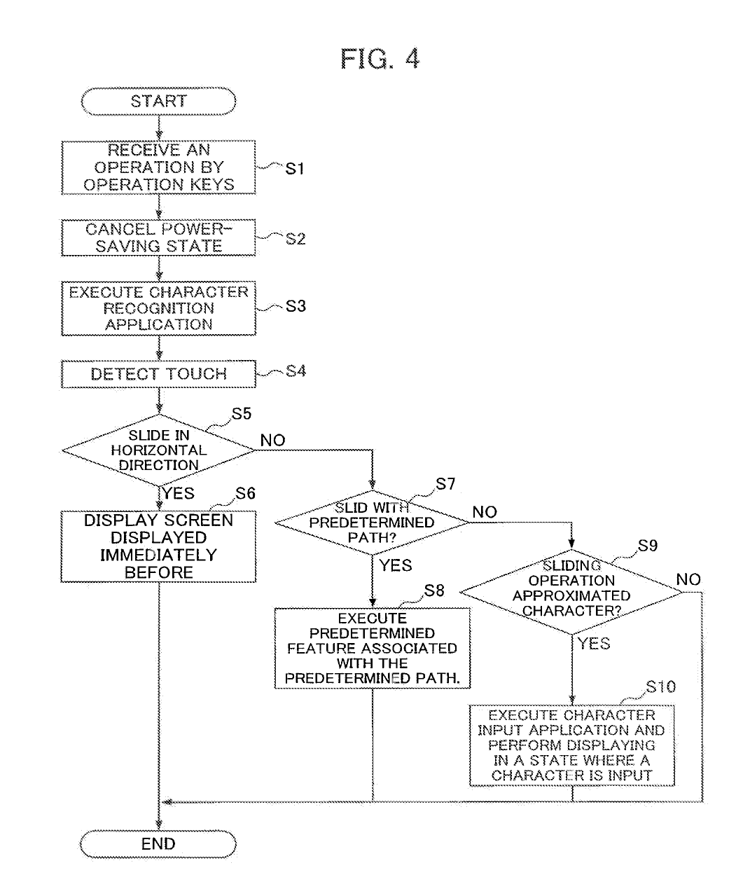

FIG. 4 is a flowchart showing internal processing of the control unit 17 according to the present embodiment. In Step S1, the control unit 17 receives an operation by the operation keys 9 in the power-saving state.

In Step S2, when any of the operation keys 9 is operated, the control unit 17 cancels the power-saving state, turns on the display unit 11, and transitions to the restricted state where the detecting unit 12 can detect a touch.

In Step S3, the control unit 17 executes the character recognition application that recognizes a detected touch as a character. In Step S4, the detecting unit 12 detects a touch to the surface.

In Step S5, the control unit 17 determines whether the detected touch is a sliding operation in a horizontal direction. In a case in which the touch is the sliding operation in the horizontal direction (YES), the processing advances to Step S6. In a case in which the touch is not the sliding operation in the horizontal direction (NO), the processing advances to Step S7.

In Step S6, the control unit 17 cancels the restricted state, and causes the display unit 11 to display a screen that was displayed immediately before transitioning to the restricted state.

In Step S7, the control unit 17 determines whether the detected touch is a sliding operation having a predetermined path. In a case in which the touch is the sliding operation having a predetermined path (YES), the processing advances to Step S8. In a case in which the touch is not the sliding operation having a predetermined path (NO), the processing advances to Step S9.

In Step S8, the control unit 17 cancels the restricted state, and executes a predetermined feature that is associated with the predetermined path.

In Step S9, the control unit 17 determines whether the detected touch is a sliding operation having a path that approximates one stroke composing at least one character. In a case in which the touch is the sliding operation having a path that approximates one stroke composing at least one character (YES), the processing advances to Step S10. In a case in which the touch is not the sliding operation having a path that approximates one stroke composing at least one character (NO), the processing is terminated, and the restricted state is maintained.

In Step S10, the control unit 17 cancels the restricted state, executes the character input application, and performs displaying in a state where a predetermined sliding operation recognized by the character recognition application is input as a character.

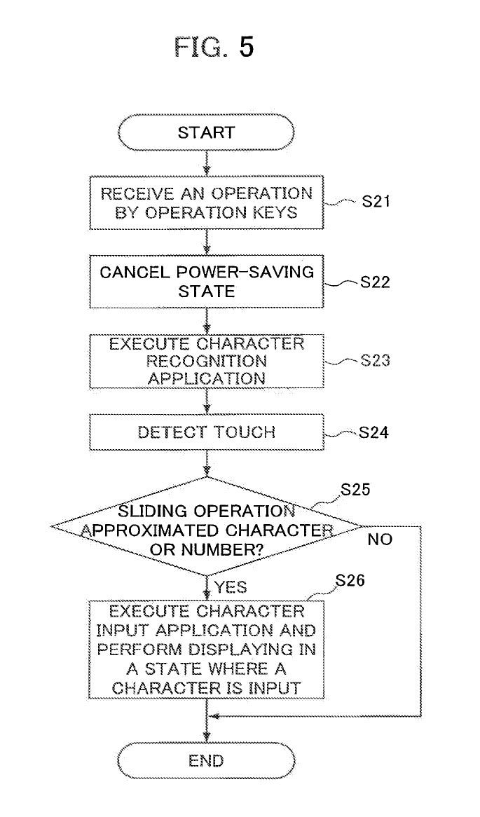

FIG. 5 is a flowchart showing processing of the control unit 17 according to the embodiment of the present invention to cancel the restricted state using a password. In Step S21, the control unit 17 receives an operation by the operation keys 9 in the power-saving state.

In Step S22, when any of the operation keys 9 is operated, the control unit 17 cancels the power-saving state, turns on the display unit 11, and transitions to a state where the detecting unit 12 can detect a touch.

At step S23, the control unit 17 executes the character recognition application that recognizes a touch detected by the detecting unit 12 as a character. In Step S24, the detecting unit 12 detects a touch to the surface.

In Step S25, the control unit 17 determines whether the touch detected by the detecting unit 12 is a sliding operation having a path that approximates one stroke composing at least one character or number. In a case in which the touch is the sliding operation having an approximated path (YES), the processing advances to Step S26. In a case in which the touch is not the sliding operation having an approximated path (NO), the processing is terminated, and the restricted state is maintained.

In Step S26, the control unit 17 executes the character input application for canceling the restricted state using a password. The control unit 17 activates the character input application, and performs displaying in a state where the sliding operation recognized by the character recognition application is input as a character into the character input application.

The embodiment of the present invention has been described above. However, the present invention is not limited to the embodiment described above, and can be modified as appropriate. For example, in the embodiment described above, when canceling the restricted state, the sliding operation in the horizontal direction or the sliding operation having an L-shaped path is used. However, other sliding operations may be used.

The aforementioned embodiment has described the examples of distinguishing the first touching operation and the second touching operation, based on the difference of the paths of the sliding operations; however, it is not limited thereto. In other words, sliding operations may be distinguished based on, for example, a period of time required for sliding operations, or variations in sliding operations. Alternatively, even if the path itself of sliding operations is the same, sliding operations may be distinguished based on, for example, whether the touching continues for more than a predetermined period of time without moving from a starting point or an ending point of the touching.

Moreover, although the mobile telephone device 1 as a mobile electronic device has been described in the aforementioned embodiment, the mobile electronic device 1 can also be applied to other electronic devices. For example, the mobile electronic device of the present invention may be a digital camera, a PHS (Personal Handyphone System), a PDA (Personal Digital Assistant), a portable navigation device, a personal computer, a notebook PC, a mobile gaming device or the like.

Although the aforementioned mobile electronic device 1 shows what is called a straight-type mobile telephone device, the type of the mobile telephone device according to the present invention is not particularly limited thereto. For example, the type of the mobile telephone device may be a slider type in which one of the bodies slides to one direction in a state in which the bodies are mutually superimposed; and a rotating (turning) type in which one of the bodies is rotated around an axis line along the direction of superimposing the bodies.

What is claimed is:

1. A mobile electronic device comprising:
a display unit;
a detecting unit that is correspondingly disposed in a surface of the display unit, and detects a touch to a surface thereof; and
a control unit that determines a touching operation based on the touch detected by the detecting unit,
wherein, in a restricted state where the touching operation is restricted, in a case in which the control unit determines that the touch thus detected is a first touching operation, the control unit cancels the restricted state, and causes the display unit to display a screen that was displayed before transitioning to the restricted state, and in a case in which the control unit determines that the touch thus detected is a second touching operation, the control unit cancels the restricted state, and executes a predetermined feature.

2. The mobile electronic device according to claim 1,
wherein the second touching operation is a first sliding operation having a path. that approximates one stroke composing at least one character, and
wherein, in a case in which the control unit determines that the touch thus detected is the first sliding operation, the control unit executes, as the predetermined feature, a character input feature for inputting a character,

3. The mobile electronic device according to claim 2, wherein the control unit includes a character recognition feature for recognizing the touching operation as a character, and in a case in which the control unit determines that the touch thus detected is the first sliding operation, the control unit executes the character input feature as the predetermined feature, and performs displaying in a state where a character recognized by the character recognition feature based on the first sliding operation is input.

4. The mobile electronic device according to claim 3, wherein the control unit includes a power-saving feature that suspends displaying on the display unit and touch detection by the detecting unit, and the control unit executes the character recognition feature in a case in which a power-saving state transitions to a restricted state.

5. The mobile electronic device according to claim 4, further comprising an operation key,
wherein the control unit cancels the power-saving state when the operation key is operated.

6. The mobile electronic device according to claim 1, wherein the second touching operation is a second sliding operation having a predetermined path, and
wherein the control unit sets the second sliding operation in association with the predetermined feature, and executes the predetermined feature in a case in which the control unit determines that the touch thus detected is the second sliding operation.

7. A mobile electronic device comprising:
a display unit;
a detecting unit that is correspondingly disposed in a surface of the display unit, and detects a touch to a surface thereof; and
a control unit that determines a touching operation based on the touch detected by the detecting unit, and includes a character recognition feature for recognizing the touching operation as a character,
wherein, in a restricted state where the touching operation is restricted, in a case in which the control unit determines that the touch thus detected is a predetermined sliding operation, the control unit executes a character input feature for cancelling the restricted state using a password, and performs displaying in a state where a character recognized by the character recognition feature based on the predetermined sliding operation is input into the character input feature.

8. An input method comprising the steps of:
determining that a touch detected by a detecting unit is a first touching operation or a second touching operation, in a restricted state where a touching operation is restricted;
cancelling the restricted state and displaying a screen that was displayed before the restricted state, in a case in which the touch is determined to be the first touching operation; and
cancelling the restricted state and executing a predetermined feature, in a case in which the touch is determined to be the second touching operation.
